(19) United States
(12) Patent Application Publication
(10) Pub. No.: US 2008/0081148 A1
(43) Pub. Date: Apr. 3, 2008

(54) Panel having a frame bonded thereto

(76) Inventor: Kenneth Bond, Shelby Township, MI (US)

Correspondence Address: PPG INDUSTRIES INC;INTELLECTUAL PROPERTY DEPT, ONE PPG PLACE, PITTSBURGH, PA, 15272, US

(21) Appl. No.: 11/520,518

(22) Filed: Sep. 13, 2006

(51) Int. Cl. B32B 3/10; B32B 23/02

(52) U.S. Cl. 428/131; 428/192

(57) ABSTRACT

An automotive sun roof panel arrangement includes a preformed or molded plastic mounting frame secured to the surface of a glass sheet by a layer of adhesive.

### BACKGROUND OF THE INVENTION

1. Field of the Invention

This invention relates to a panel having a frame bonded thereto, and more particularly, to a transparent panel having a mounting frame bonded to a major surface of the panel to provide a sun roof panel arrangement for use in vehicle sun roof systems.

2. Technical Considerations

Presently available glass sun roof panel arrangements for use in automotive sun roof systems include a glass panel having a steel mounting frame attached to a major surface of the panel. The mounting frame has engagement bars that are attached to a moveable track of the sun roof system to move the panel arrangement from an open or closed position to a closed or open position, respectively and to positions therebetween. The steel mounting frame is usually secured to a major surface of the panel by one of the following processes: reactive injection molding or “RIM encapsulation”, and polyvinyl chloride encapsulation or “PVC encapsulation.”

In the practice of RIM encapsulation and PVC encapsulation, an assembly, including a mounting frame to be positioned on a major surface of a shaped glass panels designed as the inside surface of the panels placed in a mold, and encapsulating material injected into the mold. After the encapsulating material cures and/or cools, the glass panel arrangement is removed from the mold. Optionally, during the encapsulation process, a weather seal is formed around the peripheral edges of the panel, or a weather seal is secured to the periphery of the panel after the encapsulating process.

Although the presently available encapsulating processes are acceptable, they have limitations or drawbacks. For example and not limiting the discussion thereto, the shape or contour of the mounting frame surface and the inside surface of the panel to be joined together are not always complimentary to one another, requiring the bending of the panel and/or the steel mounting frame during the encapsulating process to ensure surface engagement of the panel surface and the mounting frame. As can be appreciated by those skilled in the art, the bending of the panel and/or mounting frame can impose internal stresses on the glass panel, especially when the bending of one or both components of the glass sun roof panel arrangement is excessive. More particularly, the internal stresses generated during the encapsulating process can cause the glass panel to fracture.

The problem of fracturing the glass panel is significantly reduced when the panel is a tempered glass panel. Nevertheless, the stress levels of the tempered glass can be exceeded when bending the glass panel and/or the metal mounting frame to match surfaces during the encapsulating process, resulting in fracturing the tempered glass panel. Further, as can be appreciated by those skilled in the art, limiting the encapsulating processes to tempered glass minimizes, if not eliminates, the use of annealed laminated glass in the manufacture of sun roof panel arrangements. Still further, while the steel mounting frame provides structurally stability, it increases the weight of the sun roof panel arrangement. Reducing the weight of the sun roof panel arrangement contributes to a reduction in the overall weight of the vehicle, which can reduce gasoline consumption.

From the above discussion, it can now be appreciated that it would be advantages to provide a glass sun roof panel arrangement made of a shaped transparent panel, e.g. a glass or plastic panel, and a mounting frame, e.g. a metal or plastic mounting frame that does not have the limitations of the presently available glass sun roof panel arrangements.

### SUMMARY OF THE INVENTION

This invention relates to an improved sun roof panel arrangement. The sun roof panel arrangement that is improved by the non-limiting embodiments of the invention is of the type having an encapsulation having a shaped panel having a first major surface and an opposite second major surface, and a mounting frame secured on the first major surface of the panel. The mounting frame includes, a base having a first major surface and an opposite second major surface with the first major surface of the base in facing relationship to the first major surface of the panel, and the second major surface of the base of the mounting frame having components to position the encapsulation in an opening in roof of an automobile with the second major surface of the panel facing exterior of the automobile. The improvement of the invention includes but is not limited to an adhesive layer between, and securing together, the first major surface of the panel and the first major surface of the base of the mounting frame. Optionally the adhesive layer between the first major surface of the panel and the first major surface of the base of the mounting frame solely secures the panel and mounting frame together.

In another non-limiting embodiment of the invention, the base of the mounting frame surrounds an open area and the first surface of the mounting frame is secured to marginal edge portions of the first major surface of the panel. Optionally, the first major surface of the base of the mounting frame is spaced from the marginal edge portions of the first major surface of the panel by the adhesive layer and shims.

Other non-limiting embodiments include, but are not limited to (1) an opaque ceramic band adhered to marginal edge portions of the first major surface of the panel, and the adhesive layer secures the base of the mounting frame to selected portions of the ceramic band; (2) a weather seal secured to peripheral edges of the panel; (3) the base of the mounting frame made from a material selected from the group of plastic and fiber re-enforced plastic, and the panel is made of glass, and (4) the mounting frame further includes an engagement bar extend away from the first and second major surfaces of the base.

The engagement bar can be made of a material that is more structurally stable than the material of the base of the mounting frame. In one non-limiting embodiment of the invention, the engagement bar includes a first beam joined to a major surface of a second beam to provide the engagement bar with an inverted T-shape cross section with the second beam embedded in the base of the mounting frame, and in another non-limiting embodiment of the invention, the base includes an elongated cut out extending between and through the first and second major surfaces of the base, the cut out in cross section has an inverted T-shaped to receive and capture the second beam of the engagement bar in the base of the frame. The second beam is secured to the first major surface of the panel by an adhesive, and the first beam of the engagement bar extends away from the first and second major surfaces of the base.

The mounting frame in another non limiting embodiment of the invention, has a leading edge, an opposite trailing edge, a first side and an opposite second side with the first and second sides between the edges, and components for connecting the mounting frame to a moveable panel system in the roof of the automobile on the second surface of the mounting frame. The connecting components include but are not limited to a bumper member at the leading edge, a stabilizer bar at the trailing edge, a first engagement bar adjacent the first side, and a second engagement bar adjacent the second side, of the mounting frame, and a first shield adjacent the first side, and a second shield adjacent the second side, of the mounting frame with the first engagement bar between the first side and the first shield, and the second engagement bar between the second side and the second shield, of the mounting frame.

The panel in one non-limiting embodiment of the invention has a visible light transmission in the range of 0-100%, and preferably is selected from the group of glass and plastic having a visible light transmission of greater than 15% to visible light. In another non-limiting embodiment of the invention, the material of the panel is glass and the panel is selected from the group of laminated glass sheets, tempered glass sheet, heat strengthen glass sheet, annealed glass sheet, clear glass sheet, colored glass sheet, coated glass sheet and combinations thereof.

The invention still further relates to an automobile of the type having the improved sun roof panel arrangement discussed above. In one non-limiting embodiment of the invention, the mounting frame is secured to a moveable panel system in the roof of the automobile wherein the moveable panel system moves the sun roof panel arrangement from an opening in the roof to a position below outer surface of the roof. In another non-limiting embodiment of the invention, the sun roof panel arrangement is a first sun roof panel arrangement and further includes a second sun roof panel arrangement connected to the moveable panel system wherein movement of the moveable panel system moves the first and second sun roof panel arrangements in a direction between front and rear ends of the automobile.

In a still further non-limiting embodiment of the invention, the roof has a structural beam and the sun roof panel arrangement is first sun roof panel arrangement, and the mounting frame includes an engagement bar adjacent one side of the panel and adjacent one side of the structural beam. A second sun roof panel arrangement having a mounting frame defined as a second mounting frame on a major surface of the second panel, the second mounting frame having an engagement bar defined as a second engagement bar adjacent a side of the second sun roof panel arrangement and opposite side of the structural beam. A fastening assembly securing the engagement bars of the first and second transparencies to the structural beam.

### BRIEF DESCRIPTION OF THE DRAWINGS

FIG. 1 is an isometric view of inner or lower surface a non-limiting embodiment of a sun roof panel arrangement of the invention.

FIG. 2 is an elevated plan view of outer or top surface of the sun roof panel arrangement of FIG. 1.

FIG. 3 is an elevated plan view of outer surface of an automobile roof showing moveable belts of a sun roof system in phantom for moving non-limiting embodiments of the sun roof panel arrangements of the invention.

FIG. 4 is a view taken along lines 4-4 of FIG. 3.

FIG. 5 is an isometric view of a non-limiting embodiment of an engagement bar of a mounting frame of the invention that is attached to a moveable belt of a sun roof system.

FIG. 6 is: a fragmented cross sectional view of another non-limiting embodiment of an engagement bar of a mounting frame of the invention.

FIG. 7 is a fragmented view in cross section of leading edge of another non-limiting embodiment of a sun roof panel arrangement of the invention.

FIG. 8 is a fragmented plan view of inner or lower surface of a non-limiting embodiment of a vehicle sun roof made using sun roof panel arrangements of the invention.

### DETAILED DESCRIPTION OF THE INVENTION

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10. Also, as used herein, the terms “deposited over”, “applied over”, or “provided over” mean deposited, applied, or provided on but not necessarily in surface contact with. For example, a material “deposited over” a substrate does not preclude the presence of one or more other materials of the same or different composition located between the deposited material and the sheet or substrate.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise in the following discussion, like numbers refer to like elements.

In the following discussion, the description of the invention is directed to a moveable sun roof panel arrangement also referred to as a sun roof or moon window or transparency. As is appreciated, the invention is not limited thereto, and the invention can be practiced on any automotive window such as, but not limited to, a windshield, a fixed (i.e. stationary) sun roof or moon roof window, a fixed or moveable panoramic roof, a single or multiple segment roof, a side window, and a rear window. Further, the invention is not limited to windows for automobiles, and the invention can be practiced on windows for any type of commercial and military vehicles including but not limited to land vehicles other than automobiles such as, but not limit to trucks, motorcycles, and/or trains; to air and space vehicles, and to above and/or below water vehicles. Still further, the invention can be practiced on windows for residential homes, commercial buildings, oven doors, microwave ovens and refrigerator doors.

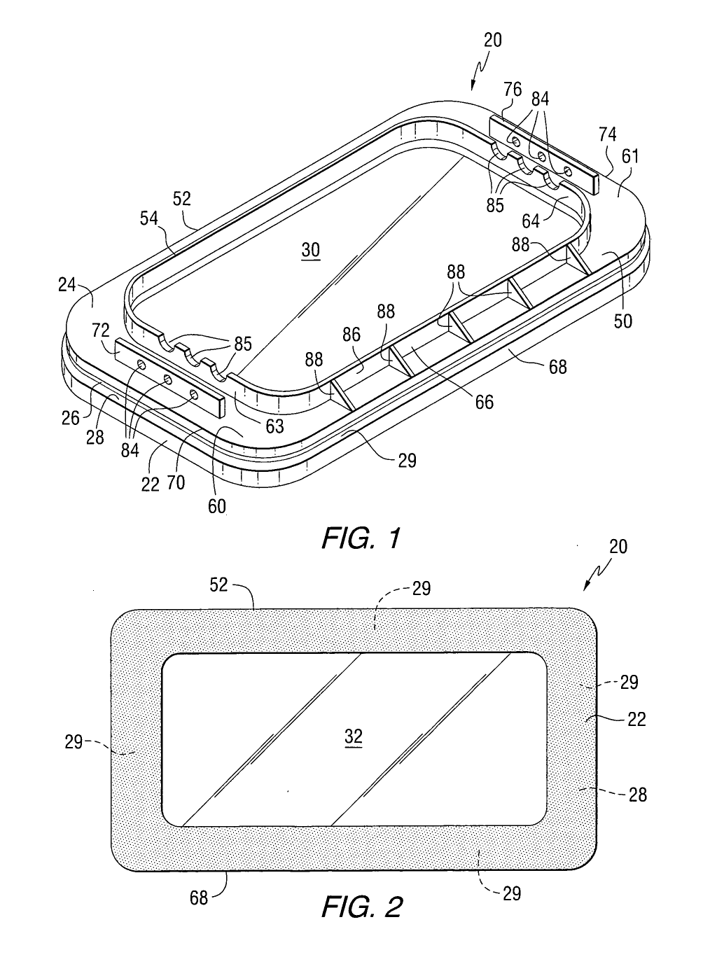

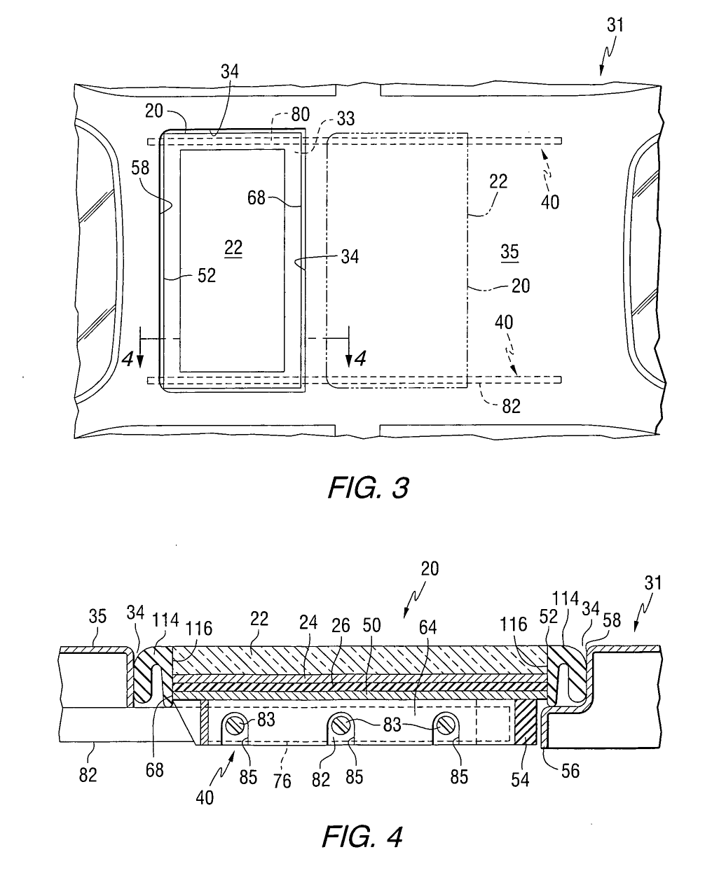

With reference to FIGS. 1 and 2, there is shown a non-limiting embodiment of a sun roof panel arrangement 20 including a panel 22 having a mounting frame 24 having features of the invention secured by adhesive layer 26 on opaque band 28 (see FIG. 2) to marginal edge portions 29 of inner or lower major surface 30 of the panel 22. As is appreciated, the inner or lower major surface 30 of the panel 22 faces the interior (not shown) of automobile 31 (see FIG. 3), and outer or upper major surface 32 of the panel 22 (see FIG. 2) faces the exterior of the automobile 31. In a non-limiting embodiment of the invention, the panel 22 is sized and configured to fit into opening 34 in roof 35 of the automobile 31 (see FIG. 3), and the outer surface 32 of the panel 22 is shaped to follow the contour of the roof 35. The invention is not limited to the contour and/or shape of the major surfaces 30 and 32, and/or thickness, of the panel 22.

The material of the panel 22 is not limiting to the invention, and in one non-limiting embodiment of the invention, the panel 22 is made from a material selected from the group including but not limited to polymeric materials, ceramic materials, glass-ceramic materials, glass materials, e.g. but not limiting to the invention soda-lime-silicate glass, borosilicate glass, or any type of refractory glass and combinations thereof. In addition, the invention can be practiced with the panel 22 having 0-100% transmission of ultraviolet radiation, visible light, and/or infrared radiation. Panels 22 having 0% visible light transmission, e.g. having a wavelength of 400-700 nanometers of the electromagnetic spectrum, include opaque panels, e.g. but not limiting to the invention, panels made of wood, metal or plastic, and panels made of a sheet having visible light transmission greater than 0% and having an opaque coating or film over one or both major surfaces of the sheet. Panels 22 having a visible light transmission greater than 0% include, but are not limited to panels, made of glass and plastic.

In one non-limiting embodiment of the invention, the panel 22 is a soda-lime-silicate glass having a visible light transmittance of greater than 0%, e.g. at least 15%. The glass panel 22 can be a clear or tinted glass, e.g. glass of the type disclosed in U.S. Pat. Nos. 5,030,592; 5,240,886; 5,593,929, and 5,792,559, which patents are hereby incorporated by reference. The glass panel 22 can be annealed, chemically or thermally tempered, or heat strengthened. Further, the glass panel can be a monolithic glass panel or laminated glass panel, e.g. two glass sheets laminated together in any usual manner, e.g. by a sheet of polyvinyl butyral, urethane, silicone and combinations thereof.

In other non-limiting embodiments of the invention, one or both of the major surfaces 30 and 32 of the panel 22 can be coated with functional coatings including, but not limited to environmental coatings, to selectively pass predetermined wavelength ranges of light and energy, e.g. glass or plastic transparent sheets can have coatings of the type disclosed in U.S. Pat. Nos. 4,170,460; 4,239,816; 4,462,884; 4,610,711; 4,692,389; 4,719,127; 4,806,220; 4,853,256 and 4,898,789, or coatings to remove moisture or surface contaminants such as a photocatalytic film or water reducing film, e.g. of the type disclosed in U.S. Pat. No. 5,873,203; U.S. Pat. No. 6,027,766; and U.S. Pat. No. 6,027,766. The disclosures of the patents are hereby incorporated by reference.

In a non-limiting embodiment of the invention, the opaque band 28 is applied to the marginal edge portions 29 of the inner major surface 30 of the glass panel 22 to hide the mounting frame 24 when viewing the sun roof panel arrangement 20 through the outer major surface 32 and to prevent or minimize ultraviolet degradation of the adhesive layer 26. The opaque band 28 is applied to the marginal edge portions 29 of the inner major surface 30 of the panel 22 in any convenient manner. For example and not limiting to the invention, a glass frit in an opaque fluid carrier is screen printed onto the marginal edge portions 29 of the glass panel 22, and the frit is fired onto the marginal edge portions 29. The technique of applying an opaque layer to marginal edge portions of a glass panel is well known in the art and no further discussion is deemed necessary. As can now be appreciated, the invention contemplates the glass panel 22 without the opaque band 28 and securing the mounting frame 24 by the adhesive layer 26 directly to the marginal edge portions 29 of the inner major surface 30 of the glass panel 22. In this instance and although not required, the panel 22 can be a solar control glass, e.g. a glass composition having additives to reduce transmission of ultraviolet radiation and thus reduce or prevent ultraviolet degradation of the adhesive layer 26.

The invention is not limited to the material of the adhesive layer 26 and any adhesive known in the art to secure mounting members to glass can be used in the practice of the invention. Adhesives that can be used in the practice of the invention include, but are not limited to, urethane adhesives and silicone adhesives. Further, the invention is not limited to using adhesives to secure the mounting frame to the glass panel 22, and any type of securing arrangement can be used, for example, but not limiting in the invention, holes (not shown) can be drilled in the panel 22, and the mounting frame 24 secured to the panel 22 by a nut and bolt arrangement (not shown) of the type used in the art to secure window hardware to a glass transparency.

The invention is not limited to the shape or configuration of the mounting frame 24, and in one non-limiting embodiment of the invention, the mounting frame 24 provides faculties discussed below for attachment of the sun roof panel arrangement 20 to panel moving system 40 in the roof 35 of the automobile 31 shown in FIG. 3, to move the sun roof panel arrangement 20 into a closed position with the sun roof panel arrangement 20 in the opening 34 in the roof 35; into an open position with the sun roof panel arrangement 20 in its maximum open position (the sun roof panel arrangement 20 in its maximum open position shown in phantom in FIG. 3), and to selected positions between the open and closed positions. In another non-limiting embodiment of the invention, the panel moving system can move two or more sun roof panel arrangements from an open position to a closed position and positions in between, e.g. as disclosed in U.S. Pat. No. 5,803,534. When multiple sun roof panel arrangements are used, the sun roof panel arrangements can have differing sizes, and can be made of different materials. Panel moving systems for moving sun roof panel arrangements are disclosed in, but not limited to U.S. Pat. Nos. 5,335,961; 6,264,270 B1; 6,270,154 B1; 6,457,771 B2; 6,648,405 B2, and 6,942,284 B2, and U.S. Patent Publication No. U.S. 2005/0082882 A1 and no further discussion is deemed necessary. The foregoing identified documents are hereby incorporated by reference.

Referring back to FIG. 1, in one non-limiting embodiment of the invention, the mounting frame 24 is molded, preformed or machined, and in another non-limiting embodiment of the invention the mounting frame is molded plastic. The invention is not limited to the material of the mounting frame; however, in the selection of the material for the mounting frame, consideration should be given to the environment in which sun roof panel arrangement is used, the application of the mounting frame, and the structural requirements. For example, and not limiting to the discussion and the invention, the mounting frame should be capable of withstanding the stresses imposed on the mounting frame as the sun roof panel arrangement 20 is moved by the panel moving system 40 to the open and closed positions, and positions in between. Materials that can be used in the practice of the invention to make the mounting frame 24 include, but are not limited to, metal, wood, plastic, composite materials, fiber reinforced plastics and combinations thereof. In one non-limiting embodiment of the invention, the mounting frame is made of a material selected from the group of plastics and fiber reinforced plastics, because of their light weight and strength. Plastics that can be used in the practice of the invention include, but are not limited to, polyvinyl chloride (PVC), acrylonitrile-butadiene-styrene (ABS), polypropylene and fiber reinforced plastics, polyamides, polycarbonates, polyesters, polybutylene terephthalate (PBT), polyethylene napthalate (PEN), polycyclohexylenedimethylene terephthalate (PCTG) and polyethylene terephthalate (PET). In one non-limiting embodiment of the invention, the mounting frame 24 was molded PET. Molding articles from plastic materials is well known in the art and no detailed discussion of the molding process is deemed necessary.

Referring back to FIG. 1, in one non-limiting embodiment of the invention, the mounting frame 24 has a base 50 having an outer peripheral shape similar to the outer peripheral shape of the panel 22, and a width slightly smaller than the width of the opaque band 28 on the inner major surface 30 of the panel 22 so that the mounting frame 24 is not readily visible from outside the automobile 31. The mounting frame 24 at a leading edge 52 of the sun roof panel arrangement 20 has a bumper 54 that moves into engagement with stop member 56 in the roof 35 of the automobile 31 to align the leading edge 52 of the sun roof panel arrangement 20 with corresponding side 58 of the opening 34 in the roof 35 of the automobile 31 (see FIGS. 3 and 4). In one non-limiting embodiment of the mounting frame of the invention, the bumper 54 of the mounting frame 24 is continuous along the leading edge 52 of the sun roof panel arrangement 20, and sides 60 and 61 of the mounting frame 24 connect with shields 63 and 64, respectively. The shields 63 and 64 extend along the sides 60 and 61, respectively, of the mounting frame 24 and connect with stabilizer bar 66 at trailing edge 68 of the sun roof panel arrangement 20. Mounted between peripheral edge 70 of the side 60, and the shield 63 of the mounting frame 24 is engagement bar 72, and mounted between, peripheral edge 74 of the side 61 and the shield 64 of the mounting frame 24 is engagement bar 76, to connect the mounting frame 24 to the panel moving system 40 (see FIG. 3) in a manner discussed below.

With reference to FIGS. 1, 3 and 4 as needed, one moveable belt, e.g. moveable belt 80 of the panel moving system 40 is positioned between the engagement bar 72 and the shield 63, and another moveable belt, e.g. moveable belt 82 of the panel moving system 40 is positioned between the engagement bar 76 and the shield 64. The moveable belts 80 and 82 are connected to the engagement bars 72 and 76, respectively, by screws 83 (screws shown only in FIG. 4, and only for the moveable belt 82 and the engagement bar 76). In general and not limiting to the invention, the screws 83 pass though access holes (not shown) in the conveyor belts 80 and 82, and are fastened in holes 84 (see FIG. 1) in the engagement bars 76 and 72, respectively. With reference to FIGS. 1 and 4, the shields 63 and 64 hide the moveable conveyor belts 80 and 82, and have grooves 85 to provide access to the screws 83 to remove the sun roof panel arrangement 20 from the panel moving system 40 for repairs or replacement.

With continued reference to FIG. 1, the stabilizer bar 66 provides rigidity to the mounting frame 24, and includes an upright member 86 extending away from the base 50 and a plurality of spaced gussets 88 connected to the base 50 and upright member 86. As can be appreciated, the invention is not limited to providing a stabilizer bar, e.g. the stabilizer bar 66 at the trailing end 68 of the sun roof panel arrangement 20, and depending on the design of the panel moving system 40, other portions of the mounting frame 24 can be strengthened.

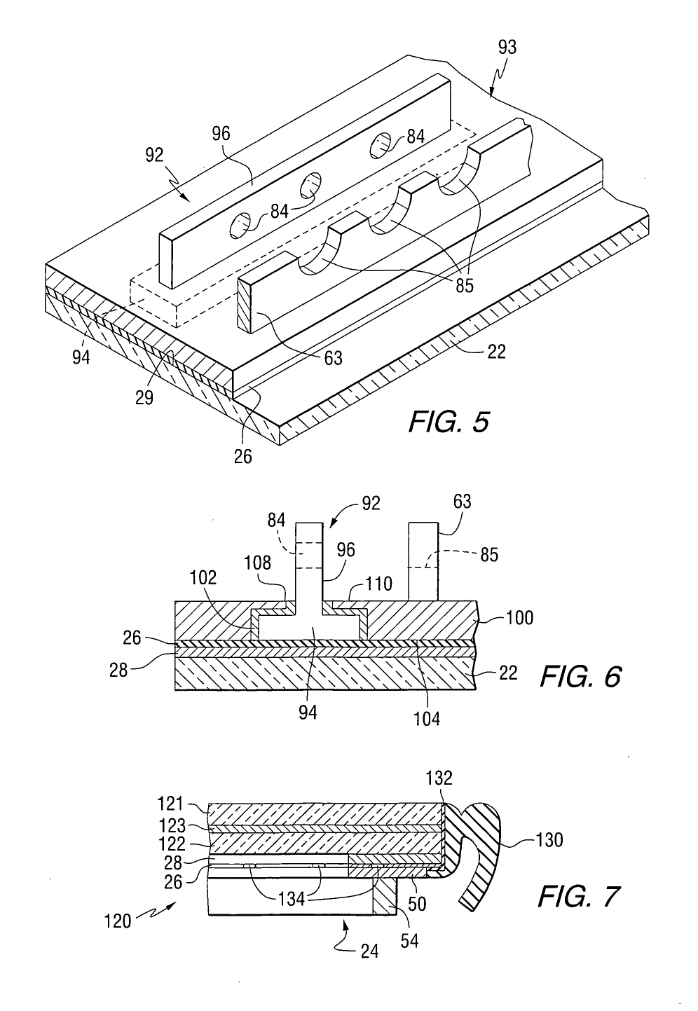

As can be appreciated by those skilled in the art, sun roof conveying systems can impose excessive stress and forces on engagement bars of mounting frames. These stress and forces can cause failure of the engagement bars 72 and 76 of the mounting frame 24 from fatigue and/or fracture of the plastic. In those instances when it is expected that excessive stresses will be applied to the engagement bars, a non-limiting embodiment of the invention contemplates making the engagement bars from metal, for example but not limiting to the invention, steel, and the remainder of the mounting frame out of plastic. More particularly and not limiting to the invention, shown in FIG. 5 is engagement bar insert 92 made of metal molded in mounting frame 93. The engagement bar insert 92 has a base 94 and an upright member 96 having the holes 84 to receive the screws 83. Molding plastic with metal inserts is known in the art, and no detailed discussion of molding inserts in plastic is deemed necessary.

Shown in FIG. 6, is another non-limiting embodiment of the invention to provide a mounting frame with an engagement bar insert. Mounting frame 100 is molded to having a recess or hole 102 open to surface 104 of base 105 of the mounting frame 100 adjacent to the panel 22 to receive the base 94 of the engagement bar insert 92, and an elongated opening 108 extending from the recess 102 to opposite surface 110 of the base 105 of the mounting frame 100 to pass the upright member 96 of the engagement bar insert 92. The surface 104 of the mounting frame 100 and the base 94 of the metal bar insert 92 are each secured to the opaque band 28 by the adhesive layer 26.

As can now be appreciated, the material of the engagement bar insert 92 is not limiting to the invention, and the insert 92 can be made of any structural stable material, for example and not limited to the invention, fiber reinforced plastic, and metals other than steel, for example and not limited to titanium.

The invention contemplates providing a weather seal around the periphery of the panel 22 of the sun roof panel arrangement 20 to prevent moisture, e.g. water from moving between the panel 22 and the walls of the opening 34 in the roof 35 of the automobile 31 when the sun roof panel arrangement 20 is in the closed position. More particularly, and with reference to FIG. 4, a weather seal 114 is applied to peripheral edges 116 of the panel 22 of the sun roof panel arrangement 20 in any convenient manner. In one non-limiting embodiment of the invention, the weather seal 114 is applied to the peripheral edges 116 of the panel 22 by an encapsulation process, and thereafter, the mounting frame 24 is secured to the panel 22 by the adhesive layer 26. In another non-limiting embodiment of the invention, the mounting frame 24 is secured to the panel 22 by the adhesive layer 26, and thereafter the weather seal 114 is secured to the peripheral edges 116 of the panel 22 by an adhesive layer, e.g. and not limiting to the invention, the adhesive layer 26.

Shown in FIG. 7 is another non-limiting embodiment of a sun roof panel arrangement of the invention. Sun roof panel arrangement 120 shown in FIG. 7 includes panels 121 and 122, e.g. and not limiting to the invention, glass panels 121 and 122 laminated together by an interlayer sheet 123. The mounting frame 24 is adhered to the opaque band 28 of the sheet 122 by the adhesive layer 26. Weather seal 130 is provided around the periphery of the panels 121 and 122. In this non-limiting embodiment of the invention, the weather seal 130 is adhered to the periphery of the panels 121 and 122 and to portions of the opaque band 28 in any convenient manner, for example and not limiting to the invention by an adhesive layer 132 of the type used in the art. The material of the weather seals 114 (FIG. 4) and 130 (FIG. 7) and the adhesive 130 is not limiting to the invention and any of the types used and/or known in the art can be used in the practice of the invention.

In the practice of another non-limiting embodiment of the invention, the base 50 of the mounting frame 24 is provided with spacing nibs or shims 134 (shown only in FIG. 7) to provide for a uniform thickness of the adhesive layer 26 between the base 50 of the mounting frame 24 and the opaque band 28. The nibs 134 can be formed on the base 50 of the mounting frame 24 when the mounting frame is molded, or adhered to the base after the mounting frame is molded.

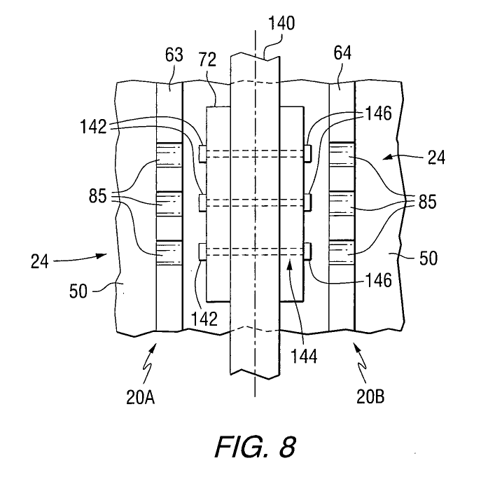

As is now appreciated, the sun roof panel arrangement of the invention can be used as a stationary window in an automotive roof, or a plurality of the sun roof panel arrangements of the invention having the same or different sizes and shapes, and made from the same or different materials can be assembled to provide an automotive roof. For example, in the non-limiting embodiment of the invention shown in FIG. 8, a pair of sun roof panel arrangements 20A and 20B are secured to a structural beam 140 in any convenient, e.g. and not limiting to the invention, by a bolt 142 of a nut and bolt arrangement 144 in the holes 84 (clearly shown in FIGS. 1 and 4) of the engagement bar 72 of the sun roof panel arrangement 20A, in holes (not shown) in the structural beam 140, through the holes 84 of the engagement bar 76 of the sun roof panel arrangement 20B, and threaded in nut 146 to secure the sun roof panel arrangements 20A and 20 to the beam 140. In another non limiting embodiment of the invention, the mounting frames 24 (FIG. 1), 93 (FIG. 5) and 100 (FIG. 6) are made without the shields 63 and 64.

Based on the description of the non-limiting embodiments of the invention, it can be appreciated that this invention is not limited to the particular non-limiting embodiments disclosed herein, but it is intended to cover modifications that are within the spirit and scope of the invention, as defined by the appended claims.

What is claimed is:

1. In a sun roof panel arrangement of the type comprising:
an encapsulation comprising a shaped panel having a first major surface and an opposite second major surface, and a mounting frame secured on the first major surface of the panel, the mounting frame comprising a base having a first major surface and an opposite second major surface with the first major surface of the base in facing relationship to the first major surface of the panel, and the second major surface of the base of the mounting frame having components to position the encapsulation in an opening of a roof of an automobile, with the second major surface of the panel facing exterior of the automobile,
wherein the improvement comprises:
an adhesive layer between, and securing together, the first major surface of the panel and the first major surface of the base of the mounting frame.

2. The sun roof panel arrangement according to claim 1, wherein the base of the mounting frame surrounds an open area and the first surface of the mounting frame is secured to marginal edge portions of the first major surface of the panel.

3. The sun roof panel arrangement according to claim 2, wherein the first major surface of the base of the mounting frame is spaced from the marginal edge portions of the first major surface of the panel by the adhesive layer and shims.

4. The sun roof panel arrangement according to claim 1, wherein the adhesive layer between the first major surface of the panel and the first major surface of the base of the mounting frame solely secures the panel and mounting frame together.

5. The sun roof panel arrangement according to claim 1, wherein the panel further comprises an opaque ceramic band adhered to marginal edge portions of the first major surface of the panel, and the adhesive layer secures the base of the mounting frame to selected portions of the ceramic band.

6. The sun roof panel arrangement according to claim 1, further comprising a weather seal secured to peripheral edges of the panel.

7. The sun roof panel arrangement according to claim 6, wherein the adhesive layer is a first adhesive layer and the weather seal is secured to the peripheral edges of the panel by a second adhesive layer.

8. The sun roof panel arrangement according to claim 1, wherein the base of the mounting frame is made from a material selected from plastic and fiber reinforced plastic, and the panel is made of glass, and the mounting frame further comprises an engagement bar extend away from the first and second major surfaces of the base.

9. The sun roof panel arrangement according to claim 8, wherein the engagement bar is made of a material that is more structurally stable than the material of the base of the mounting frame and the engagement bar comprises a first beam joined to a major surface of a second beam to provide the engagement bar with an inverted T-shape cross section with the second beam embedded in the base of the mounting frame.

10. The sun roof panel arrangement according to claim 8, wherein the engagement bar is made of a material that is more structurally stable than the material of the base of the mounting frame and the engagement bar comprises a first beam joined to a major surface of a second beam to provide the engagement bar with an inverted T-shape cross section and the base comprises an elongated cut out extending between and through the first and second major surfaces of the base, the cut out in cross section has an inverted T-shape to receive and capture the second beam of the engagement bar in the base of the frame with the second beam secured to the first major surface of the panel by an adhesive, and the first beam of the engagement bar extending away from the first and second major surfaces of the base.

11. The sun roof panel arrangement according to claim 1, wherein the mounting frame has a leading edge, an opposite trailing edge, a first side and an opposite second side with the first and second sides between the edges, and further comprises components for connecting the mounting frame to a moveable panel system in the roof of an automobile on the second surface of the mounting frame.

12. The sun roof panel arrangement according to claim 11, wherein the connecting components comprise a bumper member at the leading edge, a stabilizer bar at the trailing edge, a first engagement bar adjacent the first side, and a second engagement bar adjacent the second side, of the mounting frame.

13. The sun roof panel arrangement according to claim 12, further comprising a first shield adjacent the first side of the mounting frame and a second shield adjacent the second side of the mounting frame, with the first engagement bar between the first side and the first shield, and the second engagement bar between the second side and the second shield of the mounting frame.

14. The sun roof panel arrangement according to claim 1, wherein the panel has a visible light transmission in the range of 0-100%.

15. The sun roof panel arrangement according to claim 14, wherein the panel is made of a material selected from glass and plastic having a visible light transmission of at least 15% to visible light.

16. The sun roof panel arrangement according to claim 15, wherein the material of the panel is glass and the panel is selected from laminated glass sheets, tempered glass sheet, heat strengthen glass sheet, annealed glass sheet, clear glass sheet, colored glass sheet, coated glass sheet and combinations thereof.

17. The sun roof panel arrangement according to claim 15, wherein the vehicle is selected from land vehicles, air vehicles, space vehicles and combinations thereof and wherein the land vehicle is selected from the group of automobiles, trucks, motorcycles, and/or trains.

18. An automobile of the type having a sun roof panel arrangement, wherein the sun roof panel arrangement is of the type comprising:
an encapsulation comprising a shaped panel having a first major surface and an opposite second major surface, and a mounting frame secured on the first major surface of the panel, the mounting frame comprising a base having a first major surface and an opposite second major surface with the first major surface of the base in facing relation to the first major surface of the panel, and the second major surface of the base of the mounting frame having components to position the encapsulation in an opening in roof of an automobile with the second major surface of the panel facing exterior of the automobile,
wherein the improvement comprises:
an adhesive layer between, and securing together, the first major surface of the panel and the first major surface of the base of the mounting frame.

19. The automobile according to claim 18, wherein the mounting frame further comprises attachments secured to a moveable panel system in the roof of the automobile, wherein the moveable panel system moves the sun roof panel arrangement from an opening in the roof to a position below outer surface of the roof.

20. The automobile according to claim 19, wherein the sun roof panel arrangement is a first sun roof panel arrangement, and further comprising a second sun roof panel arrangement connected to the moveable panel system wherein movement of the moveable panel system moves the first and second sun roof panel arrangements in a direction between front and rear ends of the automobile.

21. The automobile according to claim 18, wherein the roof has a structural beam and the sun roof panel arrangement is first sun roof panel arrangement, and the mounting frame further comprises an engagement bar adjacent one side of the panel and adjacent one side of the structural beam, a second sun roof panel arrangement having a mounting frame defined as a second mounting frame on a major surface of the second panel, the second mounting frame having an engagement bar defined as a second engagement bar adjacent a side of the second sun roof panel arrangement and opposite side of the structural beam and a fastening assembly securing the engagement bars of the first and second transparencies to the structural beam.
